(19) United States
(12) Patent Application Publication
(10) Pub. No.: US 2006/0018072 A1
(43) Pub. Date: Jan. 26, 2006

(54) Load coil with digital signal bypass technology

(75) Inventors: Donald Smith, Vinemont, AL (US); Steven Ryals, Pinson, AL (US)

Correspondence Address: Merchant & Gould P.C., P.O. Box 2903, Minneapolis, MN, 55402-0903, US

(73) Assignee: BellSouth Intellectual Property Corporation

(21) Appl. No.: 10/898,127

(22) Filed: Jul. 23, 2004

(51) Int. Cl. H02H 1/00

(52) U.S. Cl. 361/113

(57) ABSTRACT

An apparatus including a load coil to be placed in series with a transmission line to compensate for capacitance in the transmission line is provided. The apparatus further includes low and high pass filters. The low pass filters allow analog signals to pass through the load coil while blocking from the load coil any digital signals present. The low pass filters include a first low pass filter electrically connected in series at an inbound connection of the load coil and a second low pass filter connected at an outbound connection of the load coil. The low pass filters are to be electrically connected in series with the transmission line. The high pass filter is electrically connected in parallel with a series combination of the load coil and the low pass filters to exclude the digital signals from the load coil.

### FIELD OF INVENTION

The present invention relates to capacitance compensation devices for transmission lines. More particularly, the present invention relates to load coils having digital subscriber line (DSL) bypass technology for twisted pair transmission lines used in telephone service.

### BACKGROUND OF THE INVENTION

As the communications needs in a particular area or neighborhood change, the flexibility of the network for that area may also change. Although plain old telephone service (POTS) and DSL service are both delivered via twisted pair transmission lines, those two services have different specifications for performance. For example, distributed stray capacitance of twisted pair lines causes an insertion loss that hinders the performance of voice services. When a POTS line is over 18,000 feet in length, load coils that cancel out stray capacitance on a line must be added to the POTS line beginning at 3000 feet from the central office (CO) and repeating every 6000 feet to the customer's premises. The added load coils compensate for the distributed stray capacitance and thus, keep voice services clear across the transmission lines over long distances.

However, these added load coils also increase the insertion loss at frequencies above the voice services band. This loss is a problem for services such as asynchronous digital subscriber line (ADSL), which operates using high frequency signals. The problem is that DSL signals cannot be transmitted via transmission lines that have load coils installed because DSL signals cannot pass through a load coil. As customers move away and cancel their POTS service, the transmission line with load coils (loaded pair) becomes available. Should a new customer order DSL provisioned via the available loaded pair, a technician must cut the load coils from the loaded pair before it can be used for conveying DSL. This results in service delays and wasted labor and expenses.

It is with respect to these and other considerations that the present invention has been made.

### SUMMARY OF THE INVENTION

In accordance with the present invention, the above and other problems are solved by embodiments of the present invention. Illustrative embodiments of the present invention are directed to load coils with DSL bypass technology. The present invention allows for the transmission of both digital, e.g., DSL, and analog, e.g., POTS, signals via a loaded pair. A load coil with digital signal bypass technology will block digital signals away from the load coil and pass analog signals through the load coil. The present invention addresses problems such as, but not limited to, those mentioned above by adding high and low pass filters to a base section of the standard load coil. Thus, the present invention reduces service delays, wasted labor, and expenses.

One illustrative embodiment of the present invention is an apparatus including a load coil to be placed in series with a transmission line to compensate for capacitance in the transmission line. The apparatus also includes low pass filters. One low pass filter is electrically connected in series at an inbound connection of the load coil and a second low pass filter is connected at an outbound connection of the load coil. The low pass filters are to be electrically connected in series with the transmission line to pass analog signals on the transmission line through the load coil and exclude ADSL signals on the transmission line from the load coil. Although the present and following discussion refer to ADSL signals, it should be understood that the present invention applies equally to synchronous digital subscriber lines and service as well as asynchronous digital subscriber lines and service.

The apparatus also includes a high pass filter electrically connected in parallel with a combination of the load coil in series with the low pass filters. The high pass filter is to be electrically connected in series with the transmission line to exclude the ADSL signals from the load coil.

Another illustrative embodiment of the present invention is a digital signal bypass filter in a load coil. The load coil is of the type to be spliced in series with a dual conductor transmission line to compensate for capacitance in the dual conductor transmission line for transmitting analog signals. The digital signal bypass filter includes a first capacitor electrically connected in parallel with the load coil. The first capacitor is to be electrically connected in series with a first conductor of the dual transmission line. The digital signal bypass filter also includes a second capacitor electrically connected in parallel with the load coil. The second capacitor is to be electrically connected in series with a second conductor of the dual transmission line. The first and second capacitors pass digital signals on the transmission line away from the load coil and block analog signals away from the digital signal bypass filter.

Still another illustrative embodiment of the present invention is a bypass filter connected to a load coil and an incoming and outgoing wire pair. The bypass filter includes a first inductor connected in series between a first lead of the incoming wire pair and the load coil and a second inductor connected in series between a second lead of the incoming wire pair and the load coil. The first inductor and second inductor pass an analog signal on the incoming wire pair to the load coil. The bypass filter further includes a first capacitor and a second capacitor. The first capacitor is connected in parallel with the load coil and in series between the first lead of the incoming wire pair and a first lead of the outgoing wire pair. The second capacitor is connected in parallel with the load coil and in series between the second lead of the incoming wire pair and a second lead of the outgoing wire pair.

These and various other features as well as advantages, which characterize the present invention, will be apparent from a reading of the following detailed description and a review of the associated drawings. It is intended that all such additional features and advantages be included within this description, be within the scope of the present invention and be protected by the accompanying claims.

### BRIEF DESCRIPTION OF THE DRAWINGS

The invention will be further understood from the following description with reference to the accompanying drawings, in which:

FIG. 1 is a block diagram of a telecommunications system with load coils in a transmission line;

FIG. 2 is a perspective view of a known prior art load coil;

FIG. 3 is a perspective view of a load coil device with a base section that includes digital signal bypass technology according to an illustrative embodiment of the present invention;

FIG. 4 is a circuit diagram of the load coil device shown in FIG. 3 shown in circuit with an idealized telephone line; and

FIG. 5 is an open front view of the load coil device shown in FIG. 3.

### DETAILED DESCRIPTION

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

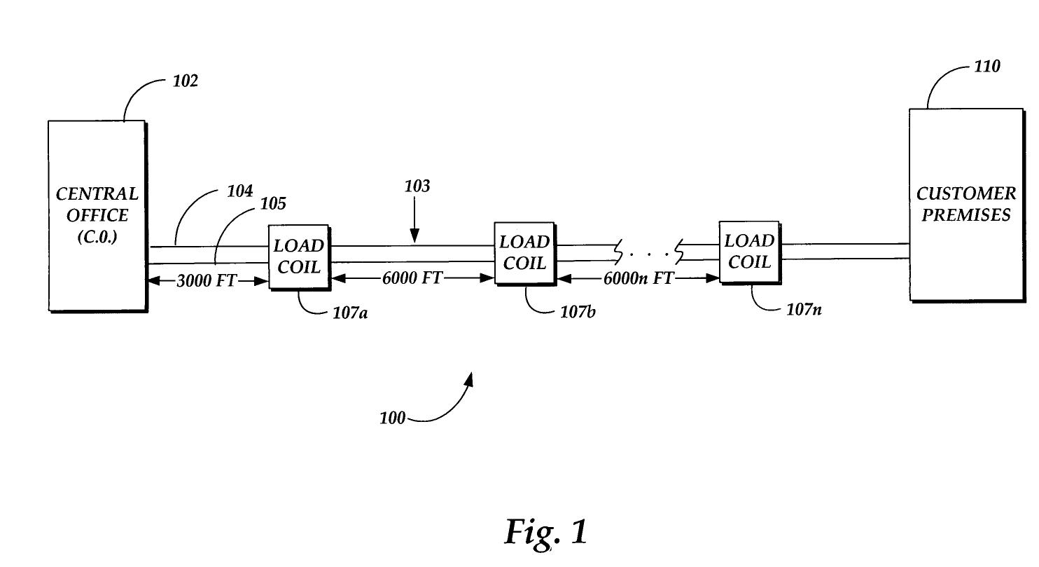

Referring to FIG. 1, a telecommunications system 100 including a CO 102, load coils 107a-107n, transmission line 103, and customer premises 110 is shown. The transmission line is a twisted pair and has conductors 104 and 105 connected between the CO 102 and the customer premises 110. The load coils 107a-107n are distributed along the transmission line 103 beginning at 3000 ft from the CO 102 and repeating every 6000 ft until reaching the customer premises 110. It should be understood that n represents the number of load coils installed between the load coil 107b and the customer premises 110. The load coils 107 compensate for the stray capacitance in the transmission line 103, as is known in the art.

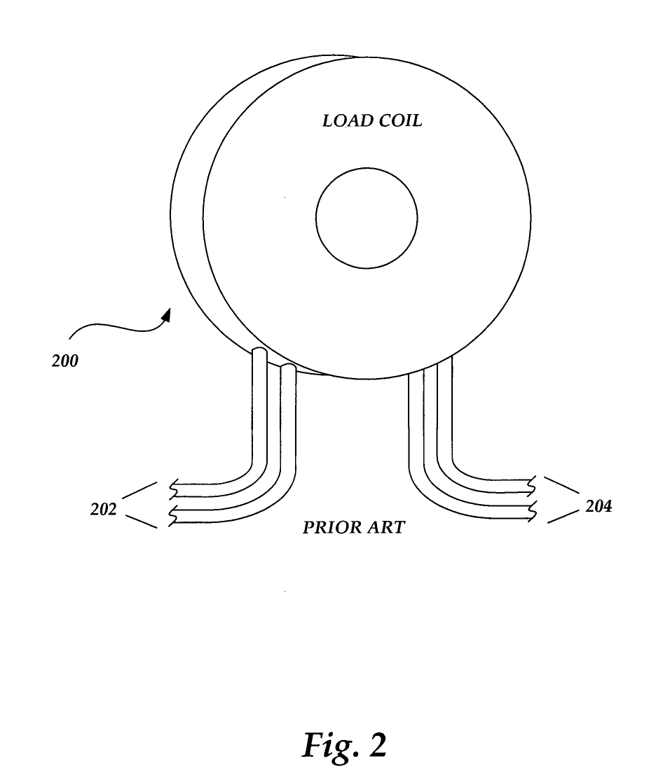

FIG. 2 is a perspective view of a known load coil 200 in the prior art. The load coil 200 is hard spliced into the circuit for POTS lines that exceed 18,000 ft in length to improve voice quality and reduce signal loss. The load coil is spliced into the circuit utilizing the incoming leads or in facilities 202 and outgoing leads or out facilities 204. DSL signals will not pass through the load coil 200 due to the reactance of the inductor inside to the high frequency of DSL signals.

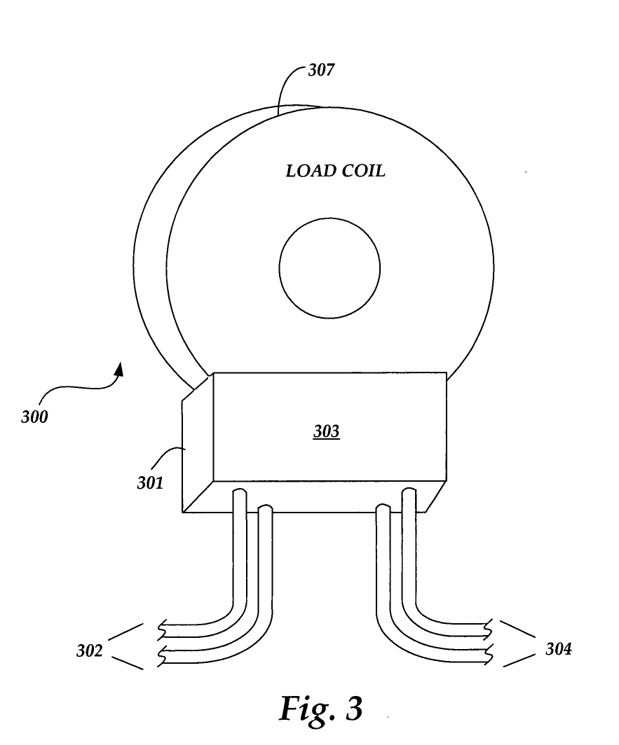

Turning now to FIG. 3, a perspective view of a load coil device 300 having a load coil 307 with a base section 303 that includes DSL bypass technology will be described. The load coil 307 will perform the same function as the standard load coil 200 of FIG. 2. However, the load coil device 300 will also allow DSL signals to pass through. The passing of DSL signals is possible due to low pass and high pass filters located in the base section 303 including a housing 301. The low and high pass filters route the signals based on the frequency band of the signal. High frequencies bypass the load coil and pass directly from the incoming leads of in facilities 302 to the outgoing leads or out facilities 304 that carry the signal in the direction of the customer premises 110 shown in FIG. 1.

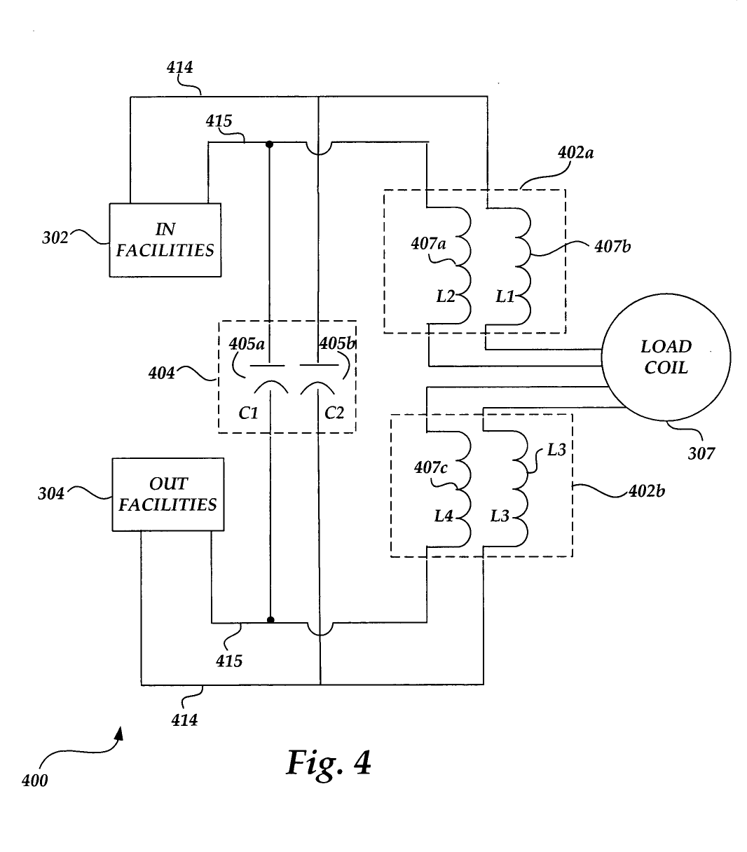

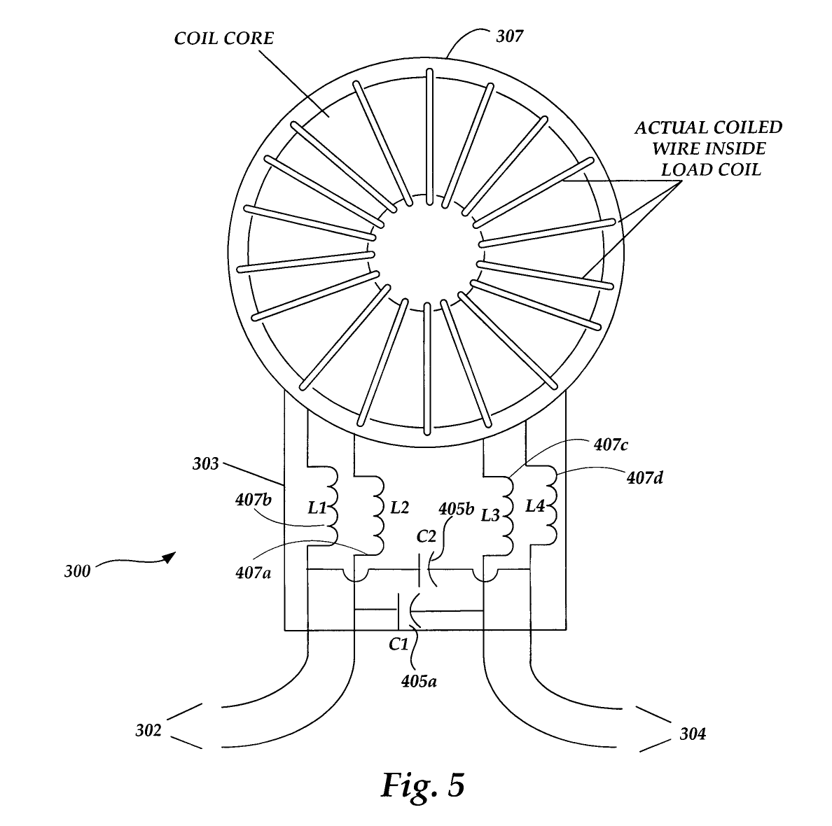

In contrast, low frequencies are passed through the load coil 307 and then toward the customer premises 110. The load coil device 300 improves network flexibility because no technicians will have to dispatch to remove load coils from transmission lines conveying DSL signals. Nor will technicians dispatch to return load coils to POTS transmission lines where load coils were previously removed to carry DSL. It should be appreciated that the load coil device 300 may be a single set load coil, meaning that each load coil device is manufactured separately with its own filters. Additional details regarding the low pass and high pass filters will be described below with respect to FIGS. 4-5.

FIG. 4 is a circuit diagram of the load coil device of FIG. 3 with DSL bypass technology in accordance with embodiments of the present invention. The load coil device circuit 400 includes the load coil 307 to be placed in series with a transmission line at the in facilities 302 to compensate for capacitance in the transmission line. The load coil device circuit 400 also includes low pass filters 402a and 402b. The low pass filter 402a is electrically connected in series at an inbound connection of the load coil 307. The low pass filter 402b is connected at an outbound connection of the load coil 307. The low pass filters 402a and 402b are to be electrically connected in series with the transmission line to pass POTS signals on the transmission line through the load coil 307 and exclude DSL signals on the transmission line from the load coil 307 while permitting passage of the relatively lower frequency POTS signals.

A high pass filter 404 is electrically connected in parallel with the combination of the load coil 307 and the low pass filters 402a and 402b. The high pass filter 404 is to be electrically connected in series with the transmission line extending between the in facilities 302 and the out facilities 304 to bypass the DSL signals around the load coil 307.

The transmission line with which the apparatus is to be used includes a pair of conductors 414 and 415. The low pass filters 402a and 402b each include an inductor 407a and 407c to be electrically connected in series with the conductor 415 of the pair, respectively at an inbound connection and an outbound connection of the load coil 307. The low pass filters 402a and 402b also respectively include second inductors 407b and 407d to be electrically connected in series with the conductor 415 of the pair, respectively at an inbound connection and an outbound connection of the load coil 307.

Additionally, the high pass filter 404 includes a first capacitor 405a electrically connected in parallel with the inductors 407a and 407c and the load coil 307. The first capacitor 405a is electrically connected in series with the conductor 415 of the transmission line. The high pass filter 404 also includes a second capacitor 405b electrically connected in parallel with the inductors 407b and 407d and the load coil 307. The second capacitor 405b is to be electrically connected in series with the conductor 414 of the transmission line.

FIG. 5 is an open front view of the load coil device 300 of FIG. 3 with DSL bypass technology in accordance with embodiments of the present invention. In operation, the capacitors 405a and 405b of the load coil device 300 will allow DSL signals to pass through, thereby bypassing the load coil 307, while blocking the low frequency POTS signals. Having the POTS signals blocked by the capacitors 405a and 405b forces the POTS signals through the load coil 307. Conversely, the inductors 407a-407d pass POTS signals while blocking any DSL signals present. The capacitors 405 and inductors 407 are reactive to alternating current and act together to route both POTS and DSL signals in the proper manner with no interaction from a field technician or other personnel.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An apparatus comprising:
a load coil to be placed in series with a transmission line to compensate for capacitance in the transmission line;
low pass filters including a first low pass filter electrically connected in series at an inbound connection of the load coil and a second low pass filter connected at an outbound connection of the load coil, the low pass filters to be electrically connected in series with the transmission line to pass analog signals on the transmission line through the load coil and exclude digital signals on the transmission line from the load coil; and
a high pass filter electrically connected in parallel with a series combination of the load coil and the low pass filters, the high pass filter to be electrically connected in series with the transmission line to exclude the digital signals from the load coil,
whereby the low pass filters allow the analog signals to pass through the load coil while blocking from the load coil any digital signals present.

2. The apparatus of claim 1, wherein the transmission line with which the apparatus is to be used comprises a pair of conductors and wherein the low pass filters each include a first inductor to be electrically connected in series with a first conductor of the pair at one of an inbound connection and an outbound connection of the load coil, and a second inductor to be electrically connected in series with a second conductor of the pair at one of an inbound connection and an outbound connection of the load coil.

3. The apparatus of claim 2, wherein the high pass filter includes:
a first capacitor electrically connected in parallel with a series combination of the first inductor and the load coil, the first capacitor to be electrically connected in series with the first conductor of the transmission line; and
a second capacitor electrically connected in parallel with a series combination of the second inductor and the load coil, the second capacitor to be electrically connected in series with the second conductor of the transmission line.

4. The apparatus of claim 1, further comprising a housing enclosing the low pass filters and the high pass filter.

5. The apparatus of claim 4, wherein the housing forms a base section of the load coil.

6. The apparatus of claim 1, wherein the analog signals comprise POTS signals.

7. The apparatus of claim 1, wherein the digital signals comprise DSL signals.

8. In a load coil of the type to be spliced in series with a dual conductor transmission line to compensate for capacitance in the dual conductor transmission line for transmitting analog signals, wherein the improvement comprises:
a digital signal bypass filter including:
a first capacitor electrically connected in parallel with the load coil, the first capacitor to be electrically connected in series with a first conductor of the dual transmission line;
a second capacitor electrically connected in parallel with the load coil, the second capacitor to be electrically connected in series with a second conductor of the dual transmission line wherein the first and second capacitors pass digital signals on the transmission line away from the load coil and block analog signals away from the digital signal bypass filter.

9. The digital signal bypass filter of claim 8, further including:
a first inductor electrically connected in series at an inbound connection of the load coil, the first inductor to be electrically connected in series between the load coil and the first conductor; and
a second inductor electrically connected in series at an inbound connection of the load coil, the second inductor to be electrically connected in series between the load coil and the second conductor;
wherein the first inductor and the second inductor block digital signals from the load coil and pass analog signals through the load coil; and
wherein the first capacitor is further electrically connected in parallel with the first inductor and the second capacitor is further electrically connected in parallel with the second inductor.

10. The digital signal bypass filter of claim 9, further including:
a third inductor electrically connected in series at an outbound connection of the load coil, the third inductor to be electrically connected in series between the load coil and the first conductor; and
a fourth inductor electrically connected in series at an outbound connection of the load coil, the fourth inductor to be electrically connected in series between the load coil and the second conductor wherein the third and fourth inductors allow the analog signal through the load coil and block the digital signal from the load coil.

11. The digital signal bypass filter of claim 10, wherein the first capacitor is further electrically connected in parallel with the third inductor and the second capacitor is further electrically connected in parallel with the fourth inductor.

12. The digital signal bypass filter of claim 8, wherein the first capacitor and the second capacitor comprise a high pass filter.

13. The digital signal bypass filter of claim 9, wherein the first inductor and the second inductor comprise a low pass filter.

14. The digital signal bypass filter of claim 13, wherein the third inductor and the fourth inductor comprise a second low pass filter.

15. The digital signal bypass filter of claim 9, wherein the digital signals comprise DSL signals.

16. The digital signal bypass filter of claim 9, wherein the analog signals comprise POTS signals.

17. A bypass filter connected to a load coil and an incoming and outgoing wire pair, the bypass filter comprising:
a first inductor connected in series between a first lead of the incoming wire pair and the load coil; and
a second inductor connected in series between a second lead of the incoming wire pair and the load coil;
a first capacitor connected in parallel with the load coil and in series between the first lead of the incoming wire pair and a first lead of the outgoing wire pair; and
a second capacitor connected in parallel with the load coil and in series between the second lead of the incoming wire pair and a second lead of the outgoing wire pair;
wherein the first inductor and second inductor pass an analog signal on the incoming wire pair to the load coil.

18. The bypass filter of claim 17, wherein the first inductor and second inductor block a DSL signal on the incoming wire pair from the load coil through the first capacitor and second capacitor therein bypassing the load coil.

19. The bypass filter of claim 17, further comprising:
a third inductor connected in series between the first lead of the outgoing pair and the load coil; and
a fourth inductor connected in series between the second lead of the outgoing pair and the load coil;
wherein the third inductor and the fourth inductor pass the analog signal from the load coil to the outgoing wire pair.

20. The bypass filter of claim 19, wherein the third inductor and the fourth inductor block the digital signal from the first capacitor and the second capacitor away from the load coil to the outgoing wire pair.

21. The bypass filter of claim 19, wherein:
the first inductor and the second inductor form a first low pass filter;
the first capacitor and the second capacitor form a high pass filter; and
the third inductor and the fourth inductor form a second low pass filter.
